(19) United States
(12) Patent Application Publication
(10) Pub. No.: US 2011/0207069 A1
(43) Pub. Date: Aug. 25, 2011

(54) REDOX MASSES HAVING A SPINEL TYPE STRUCTURE AxA'x,ByB'y,O4 AND USE IN A CHEMICAL LOOPING COMBUSTION PROCESS

(76) Inventor: Arnold Lambert, Chavaney (FR)

(21) Appl. No.: 12/998,337

(22) PCT Filed: Oct. 8, 2009
(86) PCT No.: PCT/FR2009/001193

§ 371 Date: Apr. 8, 2011

(30) Foreign Application Priority Data
Oct. 10, 2008 (FR) 0805622

(51) Int. Cl. F27B 15/00; C01G 49/02; C01G 45/12; B01J 21/06; B01J 21/04; B01J 21/08; B01J 21/16

(52) U.S. Cl. 432/58; 423/594.1; 423/599; 502/304; 502/331; 502/336; 502/335; 502/324; 502/245; 502/260; 502/259; 502/61; 502/73; 502/63; 502/328

(57) ABSTRACT

The invention relates to a novel type of active mass and to the use thereof in chemical loopping combustion processes. Said active mass contains a spinel which corresponds to the formula AₓA′_{x′}B_{y}B′_{y′}O₄. The active masses according to the invention have a high oxygen transfer capacity and oxidation and reduction rates which allow their advantageous use in the looping combustion process.

### FIELD OF THE INVENTION

The present invention relates to the use of a novel type of redox active mass in CLC (chemical looping combustion) processes, the term “chemical looping” referring to a looping redox process on an active mass.

The field of the present invention is that of energy production, by gas turbines, boilers and furnaces, in particular for the oil industry, the glass industry and cement works. It also covers the use of these means for the production of electricity, heat or steam.

The field of the invention more particularly groups together devices and processes allowing the production, using reactions of oxidation-reduction of an active mass, referred to as redox mass, of a hot gas from a hydrocarbon, for example natural gas, coals or oil residues, or from a hydrocarbon mixture, and to isolate the carbon dioxide produced so as to be able to capture it with a view to storing it in geological formations.

The increase in the world energy demand leads to the building of new power plants and to the emission of increasing amounts of carbon dioxide harmful to the environment. The capture of carbon dioxide for sequestration thereof has thus become an unavoidable necessity.

One of the techniques that can be used to capture carbon dioxide consists in carrying out active-mass redox reactions in a CLC process.

A first reaction of oxidation of the active mass with air or another gas acting as the oxidant makes it possible, owing to the exothermic nature of the oxidation, to obtain a hot gas of which the energy can subsequently be exploited. A second reaction of reduction of the oxidized active mass by means of a reducing solid, liquid or gas, then makes it possible to obtain a re-usable active mass, and also a gas mixture essentially comprising carbon dioxide and water.

One advantage of this technique is that of being able to readily isolate the carbon dioxide in a gas mixture virtually free of oxygen and nitrogen.

### PRIOR ART

U.S. Pat. No. 5,447,024 describes a CLC process comprising a first reactor for reducing an active mass by means of a reducing gas and a second oxidation reactor making it possible to restore the active mass to its oxidized state by means of an oxidation reaction with moistened air.

The active mass changing alternately from its oxidized form to its reduced form and vice versa follows a redox cycle. It should be noted that, in general, the terms oxidation and reduction are used in relation to the respectively oxidized or reduced state of the active mass. The oxidation reactor is the reactor in which the redox mass is oxidized and the reduction reactor is the reactor in which the redox mass is reduced.

The gaseous effluents resulting from the two reactors are preferably fed into the gas turbines of a power plant. The chemical looping redox process makes it possible to isolate the carbon dioxide from the nitrogen, which thus facilitates carbon dioxide capture.

The document mentioned above uses the circulating bed technology to allow continuous change of the active mass from its oxidized state to its reduced state.

Thus, in the reduction reactor, the active mass (MₓO_{y}) is first of all reduced to the MₓO_{y-2n+m/2} state, by means of a hydrocarbon CₙHₘ, which is correspondingly oxidized to CO₂ and H₂O, according to reaction (1), or possibly to the mixture CO+H₂ according to the proportions used.

CₙHₘ+MₓO_{y}→nCO₂+m/2H₂O+MₓO_{y-2n+m/2} (1)

In the oxidation reactor, the active mass is restored to its oxidized state (MₓO_{y}) on contact with air according to reaction (2), before returning to the first reactor.

MₓO_{y-2n+m/2}+(n+m/4)O₂→+MₓO_{y} (2)

The same document describes, as active mass, the use of the redox couple NiO/Ni, alone or combined with the binder YSZ (which is defined by yttrium-stabilized zirconia, also called yttriated zirconia).

The advantage of the binder in such an application is to increase the mechanical strength of the particles, which is too low to be used in a circulating bed when NiO/Ni is used alone.

Since yttrium-stabilized zirconia is, furthermore, an ion conductor for O²⁻ ions at the operating temperatures, the reactivity of the NiO/Ni/YSZ system is improved.

Many types of binders, in addition to the aforementioned yttrium-stabilized zirconia (YSZ), have been studied in the literature in order to increase the mechanical strength of the particles at a lower cost than with YSZ. Among these, mention may be made of alumina, metal aluminate spinels, titanium dioxide, silica, zirconia and kaolin.

Document EP 1 747 813 describes, for its part, redox masses comprising a redox couple or a set of redox couples, chosen from the group made up of CuO/Cu, Cu₂O/Cu, NiO/Ni, Fe₂O₂/Fe₃O₄, FeO/Fe, Fe₃O₄/FeO, MnO₂/Mn₂O₃, Mn₂O₃/Mn₃O₄, Mn₃O₄/MnO, MnO/Mn, Co₃O₄/CoO and CoO/Co, in combination with a binder of ceria-zirconia type, which makes it possible to increase the oxygen transfer capacity of said masses, owing to its ability to be partially reduced and be reoxidized.

The reactivity of the redox masses involved in the CLC application is essential: the faster the oxidation and reduction reactions, the smaller the inventory of the materials required for operation of a unit. According to the literature (T. Mattison, A. Jardnas, A. Lyngfelt, Energy & Fuels 2003, 17, 643), the CuO/Cu couple has the highest reduction and oxidation rates, in front of the NiO/Ni couple. The authors note, however, that the relatively low melting point of copper (1083° C.) limits its potential for use in CLC at high temperature, and the majority of the studies published on redox masses for CLC concern the NiO/Ni couple, despite the high toxicity of nickel oxide NiO (it is classified as CMR1) and its high cost.

The use of the Fe₂O₃/Fe₃O₄ couple is also advantageous compared with that of the NiO/Ni couple, despite a low oxygen transfer, capacity, owing to its low toxicity and its low cost. Nevertheless, since Fe₃O₄ tends to be reduced to FeO, the associated oxidation and reduction rates are reduced.

As regards more particularly the use of copper in redox masses, a publication in Fuel 83 (2004) 1749 by de Diego, Garcia-Labiano et al., shows the use of copper in CLC, the copper being deposited by impregnation on a porous support (alumina, silica, titanium, zirconia or sepiolite), this resulting in a significant limitation of the amount of usable copper and therefore of the oxygen transfer capacity of the active mass. This publication specifies that the solids prepared by coprecipitation or by mechanical mixing of oxides with a high CuO content cannot be used in CLC processes.

Furthermore, another publication by these authors (L. F. de Diego, P. Gayan, F. Garcia-Labiano, J. Celaya, A. Abad. J. Adanez, Energy & Fuels 2005, 19, 1850) discloses that an impregnation rate of 10% of CuO on alumina makes it possible to avoid particle aggregation harmful to the operation of the fluidized bed process, but that this aggregation phenomenon is inevitable as soon as 20% of CuO is impregnated.

The particle aggregation phenomenon, which can compromise the use of redox masses in a fluidized bed, has also been studied by P. Cho, T. Mattison, A. Lyngfedt in the review Fuel, 83, (2004), 1215, for redox masses comprising 60% of CuO, Fe₂O₃, NiO or Mn₃O₄ and 40% of alumina used as a binder. They show that the particles based on iron and copper aggregate, unlike those based on Ni and Mn.

In general, the reaction of a metal (M) in the oxidation state +II (MO) with alumina leads, at the operating temperatures of CLC processes, to the formation of a spinel (MAl₂O₄). The spinel NiAl₂O₄ is poorly reactive and, according to Cho et al. (Ind. Eng. Chem. Res. 2005, 44, 668), the spinels CuAl₂O₄ and MnAl₂O₄ are not reactive either. In order to avoid the oxygen transfer capacity decrease induced by the formation through reaction of MO with Al₂O₃, the spinel itself can be used as a binder, but this involves an additional cost owing to the introduction of non-reactive metal.

De Diego et al. (Fuel, 86, 2007, 1036) indicate that, when a redox mass for CLC is prepared by impregnation of copper nitrate on γ-alumina, followed by calcinations, two major phases are observed by XRD (CuAl₂O₄ spinel and γ-alumina), and also a minor CuO phase. The use of this mass in a CLC process results in the gradual formation of α-alumina and of a significantly greater amount of CuO. The authors indicate that the two phases (CuO and CuAl₂O₄) are probably active during the reduction of the particles. In addition, the amount of CuO that can be used to impregnate is limited to approximately 15% by mass in order to avoid the risks of aggregation.

In French patent application Ser. No. 07/08640, the compositions Cu₁₋ₓFe₁₊ₓAlO₄, 0≦x≦0.1, having a spinel structure, and the use thereof as a redox mass, are described. We have discovered that many other compounds AₓA′_{x′}B_{y}B′_{y′}O₄ having a spinel structure exhibit advantageous properties as redox masses for chemical looping combustion processes.

### Subject of the Invention

The invention relates to redox masses comprising at least one compound which corresponds to the formula AₓA′_{x′}B_{y}B′_{y′}O₄ and which crystallizes according to the spinel structure, where:
x and x′ are real numbers ranging between 0 and 1, with x+x′=1;
y and y′ are real numbers ranging between 0 and 2, with y+y′=2;
A and A′,are selected from Mg, Ca, Mn, Fe, Co, Ni, Cu, Zn and Cd;
B and B′ are selected from the group made up of Fe, Mn, Cr, V, Ce, La, Pr, Nd, Al, Ga and In;
when (A=Cu and 0.9≦x≦1) and (B=Al and y=1) and (B′=Fe and y′=1), A′ is other than Fe;
when (A=Cu and 0.9≦x≦1) and (A′=Fe and 0≦x′≦0.1) and (B=Fe and y=1), B′ is other than Al;
when (A=Cu and x=1) and (B=Al), then 0.1≦y≦1.9 and B′ is selected from Fe, Mn, Cr, V, Ce, La, Pr, Nd, Ga and In.

The invention also relates to the use of said masses in a chemical looping redox process.

### DESCRIPTION OF THE INVENTION

### Summary of the Invention

The invention relates to a redox mass, said mass comprising at least one compound which corresponds to the formula AₓA′_{x′}B_{y}B′_{y′}O₄ and which crystallizes according to the spinel structure, where:
x and x′ are real numbers ranging between 0 and 1, with x+x′=1;
y and y′ are real numbers ranging between 0 and 2, with y+y′=2;
A and A′ are selected from Mg, Ca, Mn, Fe, Co, Ni, Cu, Zn and Cd;
B and B′ are selected from the group made up of Fe, Mn, Cr, V, Ce, La, Pr, Nd, Al, Ga and In;
when (A=Cu and 0.9≦x≦1) and (B=Al and y=1) and (B′=Fe and y′=1), A′ is other than Fe;
when (A=Cu and 0.9≦x≦1) and (A′=Fe and (B=Fe and y=1), B′ is other than Al;
when (A=Cu and x=1) and (B=Al), then 0.1≦y≦1.9 and B′ is selected from Fe, Mn, Cr, V, Ce, La, Pr, Nd, Ga and In.

Preferably, the synthesis of the compound AₓA′_{x′}B_{y}B′_{y′}O₄ is carried out in a coprecipitation step, even more preferably by coprecipitation of a mixture of metal precursors, chosen from the group of nitrates, acetates and oxalates, with a base.

In one embodiment of the invention, no binder is combined with the compound AₓA′_{x′}B_{y}B′_{y′}O₄ in the redox mass according to the invention.

In another embodiment, the redox mass according to the invention also comprises at least one binder chosen from ceria-zirconia, alumina, spinel type aluminates, silica, titanium dioxide, kaolin, yttrium-stabilized zirconia, and perovskites.

Preferably, the binder is introduced at a content of between 10% and 95% by weight.

The redox mass according to the invention can also comprise at least one redox couple chosen from the group made up of CuO/Cu, Cu₂O/Cu, NiO/Ni, Fe₂O₃/Fe₃O₄, FeO/Fe, Fe₃O₄/FeO, MnO₂/Mn₂O₃, Mn₂O₃/Mn₃O₄, Mn₃O₄/MnO, MnO/Mn, Co₃O₄/CoO and CoO/Co.

The redox mass according to the invention can be in the form of powder, of beads, of extrudates, or of a washcoat deposited on a substrate of monolith type.

The invention also relates to a chemical looping redox (CLC) process using a redox mass as described above.

The process according to the invention can use an oxidation reactor and a reduction reactor, both operating in a circulating fluidized bed, or a rotary reactor, or a simulated rotary reactor.

### DETAILED DESCRIPTION OF THE INVENTION

The spinel group consists of oxides of which the structure reproduces that of the mineral spinel MgAl₂O₄. Among the oxides having a spinel structure are many natural compounds, such as magnetite (Fe₃O₄), chromite (FeCr₂O₄) or gahnite (ZnAl₂O₄). The general formula of spinels is AB₂O₄, where A is a divalent cation and B a trivalent cation. In the spinel structure, the oxide ions (O²⁻) form a face-centered cubic network. This network has two types of interstitial sites: tetrahedral sites and octahedral sites. The primitive cubic unit cell of the spinel network has in particular 64 tetrahedral sites, among which only 8 are occupied by metal ions, and 32 octahedral sites, among which 16 are occupied. Two types of particular cation arrangements have been observed. In spinels of normal type, the trivalent ions occupy the octahedral sites and the divalent ions occupy the tetrahedral sites. Each oxide ion is thus combined with one divalent ion and three trivalent ions. In spinels of inverse type, the tetrahedral sites are occupied by one half of the trivalent ions and the octahedral sites by the other half of the trivalent ions and by the divalent ions. There are also spinels where the two types of cations occupy both the tetrahedral and the octahedral sites: these are mixed spinels for which the previous two cases are the limiting cases (SMIT and WIJN, Les Ferrites, Techn. Philipps, 1961).

The oxides of spinel structure can be prepared by means of the sintering method commonly used in the ceramics industry. This method comprises the following operations. The metal oxides, carbonates or other compounds from which the spinel is formed after a solid-state reaction are homogeneously mixed, then wetted and ground. After drying, and optionally shaping through pressing, the powder obtained is brought to a sufficient temperature (approximately 1000° C.) to cause the chemical reaction between the reactants. In order to improve the homogeneity within the structure of the material, the powder obtained can be ground and mixed again, and then brought to high temperature. These operations can be repeated as often as necessary.

The synthesis of the spinel can also be carried out using the method referred to as solution combustion synthesis, wherein a stoichiometric mixture of metal precursors (nitrates, acetates, oxalates, etc.) of the desired spinel and of a water-soluble fuel, for example urea, is heated until ignition of the mixture.

Another synthesis method, called spray pyrolysis, consists in pulverizing, into droplets of controllable size, a stoichiometric mixture of metal precursors (nitrates, acetates, oxalates, etc.) of the desired spinel, and then in introducing the aerosol thus formed into a furnace maintained at a sufficient temperature, typically above 600° C., for evaporating off the solvent and triggering the decomposition of the precursors and the formation of the spinel. The particles can subsequently be calcined again in a furnace.

One variant of this method, called spray-drying, consists in simply drying the droplets in the furnace (temperature below 300° C., preferably below 200° C.) and then in calcining the particles obtained at a sufficient temperature for triggering the decomposition of the precursors and the formation of the spinel.

The spinel can also be prepared by impregnation of an oxide, for example alumina, with a metal precursor (nitrate, acetate, oxalate, etc.), followed by calcination at a sufficient temperature for spinel formation, typically at a temperature above 600° C. A composite material of which the core consists of the support oxide (Al₂O₃) and the periphery consists of the spinel (MAl₂O₄) is thus obtained.

Preferably, the synthesis of the spinel is carried out by coprecipitation of a mixture of metal precursors, chosen from the group of nitrates, acetates and oxalates, with a base. This base is, for example, sodium hydroxide, potassium hydroxide or aqueous ammonia. The precipitate obtained is then washed, dried and calcined at a sufficient temperature for promoting spinel formation, preferably above 600° C.

The present invention relates to redox active masses comprising at least one compound which corresponds to the formula AₓA′_{x′}B_{y}B′_{y′}O₄ and which crystallizes according to the spinel structure defined above, where:
x and x′ are real numbers ranging between 0 and 1, with x+x′=1;
y and y′ are real numbers ranging between 0 and 2, with y+y′=2;
A and A′ are selected from Mg, Ca, Mn, Fe, Co, Ni, Cu, Zn and Cd;
B and B′ are selected from the group made up of Fe, Mn, Cr, V, Ce, La, Pr, Nd, Al, Ga and In;
when (A=Cu and 0.9≦x≦1) and (B=Al and y=1) and (B′=Fe and y′=1), A′ is other than Fe;
when (A=Cu and 0.9≦x≦1) and (A′=Fe and 0≦x′≦0.1) and (B=Fe and y=1), B′ is other than Al;
when (A=Cu and x=1) and (B=Al), then 0.1≦y≦1.9 and B′ is selected from Fe, Mn, Cr, V, Ce, La, Pr, Nd, Ga and In.

Preferably, B is equal to Al and y is greater than or equal to 0.5, and even more preferably, y is greater than or equal to 0.9; and B′ is selected from the group made up of Fe, Mn, Cr, V, Ce, La, Pr, Nd, Ga and In.

In these compounds, the divalent cations associated with the elements A and A′ are selected from Mg²⁺, Ca²⁺, Mn²⁺, Fe²⁺, Co²⁺, Ni²⁺, Cu²⁺, Zn²⁺ and Cd²⁺, A and A′ possibly being identical; and the trivalent cation associated with the elements B and B′ is selected from Fe³⁺, Mn³⁺, Cr³⁺, V³⁺, Ce³⁺, La³⁺, Pr³⁺, Al³⁺, Ga³⁺ and In³.

The applicant has discovered that using, in a CLC process, a redox active mass of AₓA′_{x′}B_{y}B′_{y′}O₄ spinel type defined above makes it possible to have a mass The active masses according to the invention have a high oxygen transfer capacity and oxidation and reduction rates which allow their advantageous use in the looping redox combustion process. Furthermore, they have a low cost price and a lower toxicity level compared with the known masses of the prior art, in particular the masses comprising a nickel oxide and a solution of yttrium-stabilized zirconia as binder (NiO/YSZ).

The redox mass can be in the form of powder, of beads, of extrudates or of a washcoat deposited on a substrate of monolith type.

Preferably, no binder is combined with the redox mass, since it has a negative impact on the oxygen transfer capacity.

The redox mass according to the invention can however also comprise a binder, and/or one or more redox couples chosen from the group made up of CuO/Cu, Cu₂O/Cu, NiO/Ni, Fe₂O₃/Fe₃O₄, FeO/Fe, Fe₃O₄/FeO, MnO₂/Mn₂O₃, Mn₂O₃/Mn₃O₄, Mn₃O₄/MnO, MnO/Mn, Co₃O₄/CoO and CoO/Co.

When a binder is used, it preferably contains ceria-zirconia, which is used alone, or as a mixture with other types of binders, such as alumina, spinel type aluminates, silica, titanium dioxide, kaolin, YSZ or perovskites. Preferably, the binders other than ceria-zirconia are chosen from the subgroup made up of alumina, aluminates, YSZ and perovskites.

The proportion of binder in the redox mass ranges between 10% and 95% by weight, preferably between 20% and 80% by weight, and even more preferably between 30% and 70% by weight. Advantageously, a binder is a mixed oxide containing ceria-zirconia (Ce/Zr), of general formula CeₓZr₁₋ₓO₂, with x between 0.05 and 0.95, and x preferably between 0.5 and 0.9.

The redox mass according to the present invention may be used, depending on applications, in a circulating fluidized bed, in a rotary reactor, or in a simulated rotary reactor, as described in French patent applications FR 2846710 and FR 2873750.

### Example 1

The spinel CuFeGaO₄ is prepared by coprecipitation, with sodium hydroxide, of stoichiometric amounts of copper nitrate, iron nitrate and gallium nitrate. The precipitate formed is then filtered off, washed with distilled water, dried and calcined at 1000° C. for 2 h. The resulting powder X-ray diffractogram confirms the formation of the pure spinel.

### Example 2

The spinel CuFeInO₄ is prepared by coprecipitation, with sodium hydroxide, of stoichiometric amounts of copper nitrate, iron nitrate and indium nitrate. The precipitate formed is then filtered off, washed with distilled water, dried and calcined at 1000° C. for 2 h. The resulting powder X-ray diffractogram confirms the predominant formation of the spinel, and also traces of Cu₂In₂O₅.

### Example 3

The spinel CoAlFeO₄ is prepared by coprecipitation, with sodium hydroxide, of stoichiometric amounts of cobalt nitrate, iron nitrate and aluminum nitrate. The precipitate formed is then filtered off, washed with distilled water, dried and calcined at 1000° C. for 2 h. The resulting powder X-ray diffractogram confirms the formation of the pure spinel.

### Example 4

The spinel NiAlFeO₄ is prepared by coprecipitation, with sodium hydroxide, of stoichiometric amounts of nickel nitrate, iron nitrate and aluminum nitrate. The precipitate formed is then filtered off, washed with distilled water, dried and calcined at 1000° C. for 2 h. The resulting powder X-ray diffractogram confirms the predominant formation of a spinel close to NiFe_{1.5}Al_{0.5}O₄, and also traces of NiO.

### Example 5

The spinel CuAlMnO₄ is prepared by coprecipitation, with sodium hydroxide, of stoichiometric amounts of copper nitrate, manganese nitrate and aluminum nitrate. The precipitate formed is then filtered off, washed with distilled water, dried and calcined at 1000° C. for 2 h. The resulting powder X-ray diffractorgram confirms the formation of the spinel, and also traces of CuO.

### Example 6

The spinel Cu_{0.5}Ni_{0.5}AlFeO₄ is prepared by coprecipitation, with sodium hydroxide, of stoichiometric amounts of copper nitrate, nickel nitrate, iron nitrate and aluminum nitrate. The precipitate formed is then filtered off, washed with distilled water, dried and calcined at 1000° C. for 2 h. The resulting powder X-ray diffractorgram confirms the formation of a spinel of which the unit cell parameter of 8.21 Å is intermediate between that of the FeNiAlO₄ and Fe_{1.5}NiAl_{0.5}O₄ phases, and also traces of CuO.

### Example 7

The spinel CO_{0.5}Ni_{0.5}AlFeO₄ is prepared by coprecipitation, with sodium hydroxide, of stoichiometric amounts of cobalt nitrate, nickel nitrate, iron nitrate and aluminum nitrate. The precipitate formed is then filtered off, washed with distilled water, dried and calcined at 1000° C. for 2 h. The resulting powder X-ray diffractogram indicates that the compound formed has a spinel structure of nonhomogeneous composition, the unit cell parameter varying according to the lines on which it is measured.

### Example 8—Comparative

The redox mass according to prior art is a nickel oxide NiO using, as binder, a solution of yttrium-stabilized zirconia, prepared by coprecipitation, with sodium hydroxide, of stoichiometric amounts of nickel nitrate, yttrium nitrate and zirconyl nitrate, at ambient temperature. The precipitate formed is then filtered off, dried and calcined at 1000° C. for 2 h, so as to obtain a material comprising 60% by mass of NiO and a solid solution (confirmed by X-ray diffraction) of yttrium-stabilized zirconia, containing 84% by mass of zirconia and 16% of yttria (i.e. an yttrium-stabilized zirconia containing 9 mol % Y₂O₃).

### Example 9

A Setaram thermobalance was equipped with an automated gas delivery device making it possible to simulate the successive reduction/oxidation and oxidation steps undergone by the particles in a CLC process.

The solids synthesized are tested without the use of a binder.

The tests are carried out at a temperature of 900° C., with 65 mg (±2 mg) of sample contained in a Pt boat. In order to allow comparison between the various samples, the size distribution of the particles is selected between 30 and 40 μm by screening. The reduction gas used consists of 10% CH₄, 25% CO₂ and 65% N₂, and the oxidation gas is dry air.

For safety reasons, a nitrogen sweep of the furnaces of the thermobalance is carried out systematically between the oxidation and reduction steps.

For each sample, five successive reduction/oxidation cycles are carried out according to the protocol as follows:
1) temperature rise under air (50 ml/min): from 20° C. to 800° C.: 40° C./min from 800 to 900° C.: 5° C./min
2) nitrogen sweep for 5 min 15 s, flow rate 80 ml/min
3) injection of a CH₄/CO₂ mixture for 20 min, at 50 ml/min
4) nitrogen sweep for 5 min 15 s
5) air injection, 20 min, 50 ml/min.

Steps 2 to 5 are then repeated four additional times at 900° C. Table 1 shows the average of the mass losses and gains observed upon reduction and oxidation (respectively) by the redox masses of Examples 1 to 8.

TABLE 1

| Example | Reduction | Oxidation |
|---|---|---|
| 1 | −11.4% | 11.6% |
| 2 | −8.7% | 8.2% |
| 3 | −7.5% | 7.7% |
| 4 | −13.5% | 13.5% |
| 5 | −10.3% | 10.2% |
| 6 | −10.9% | 10.9% |
| 7 | −10.6% | 10.5% |
| 8 (not in accordance with | −12.2% | 12.2% |
| the invention | | |

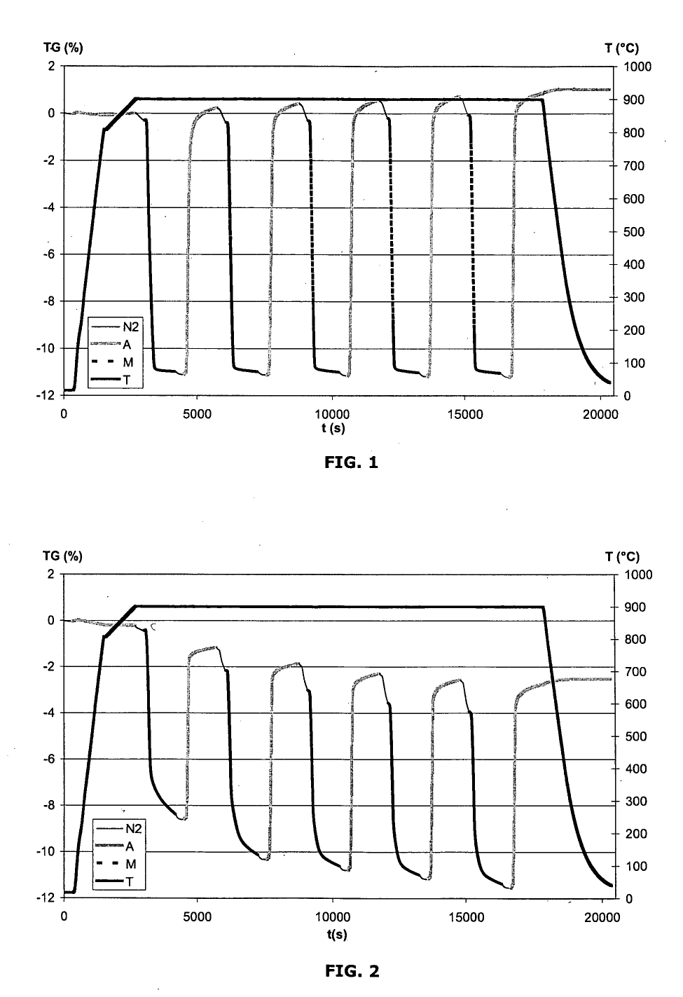

FIGS. 1 to 8 illustrate the invention in a nonlimiting manner, and refer respectively to Examples 1 to 8.

FIG. 1: Change in the mass of a sample of Example 1 as a function of the reducing or oxidizing atmosphere, at 900° C.

FIG. 2: Change in the mass of a sample of Example 2 as a function of the reducing or oxidizing atmosphere, at 900° C.

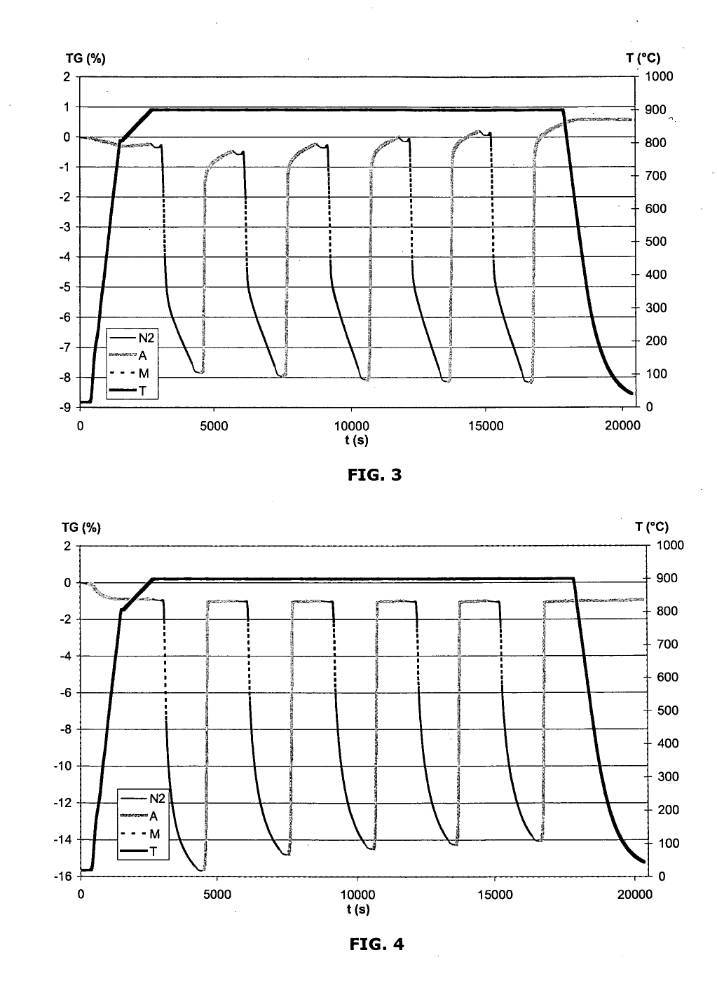

FIG. 3: Change in the mass of a sample of Example 3 as a function of the reducing or oxidizing atmosphere, at 900° C.

FIG. 4: Change in the mass of a sample of Example 4 as a function of the reducing or oxidizing atmosphere, at 900° C.

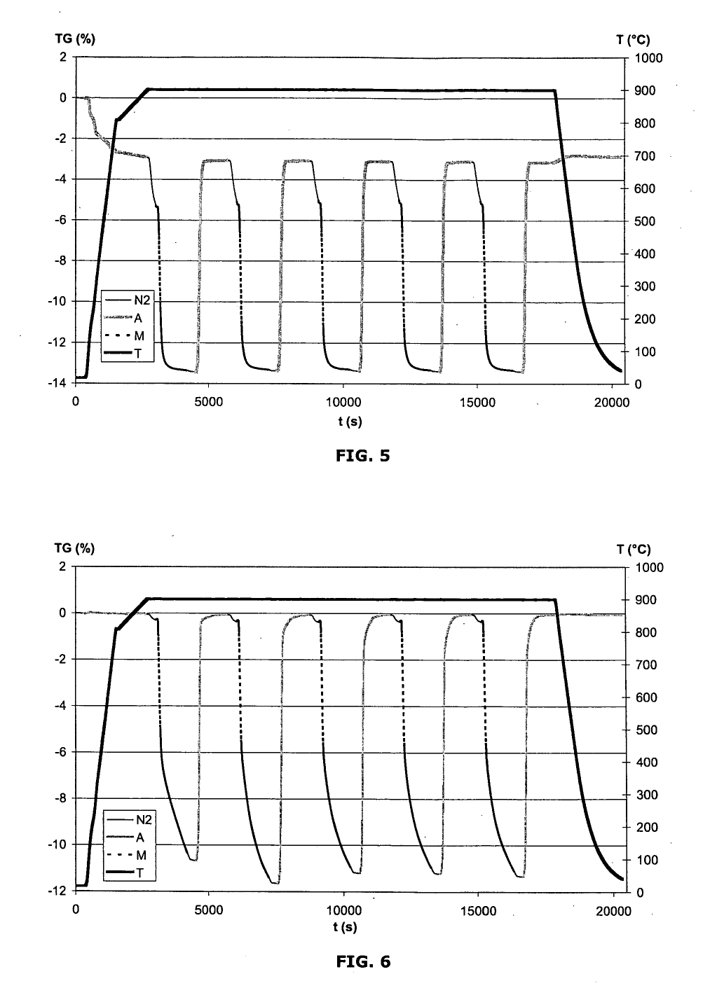

FIG. 5: Change in the mass of a sample of Example 5 as a function of the reducing or oxidizing atmosphere, at 900° C.

FIG. 6: Change in the mass of a sample of Example 6 as a function of the reducing or oxidizing atmosphere, at 900° C.

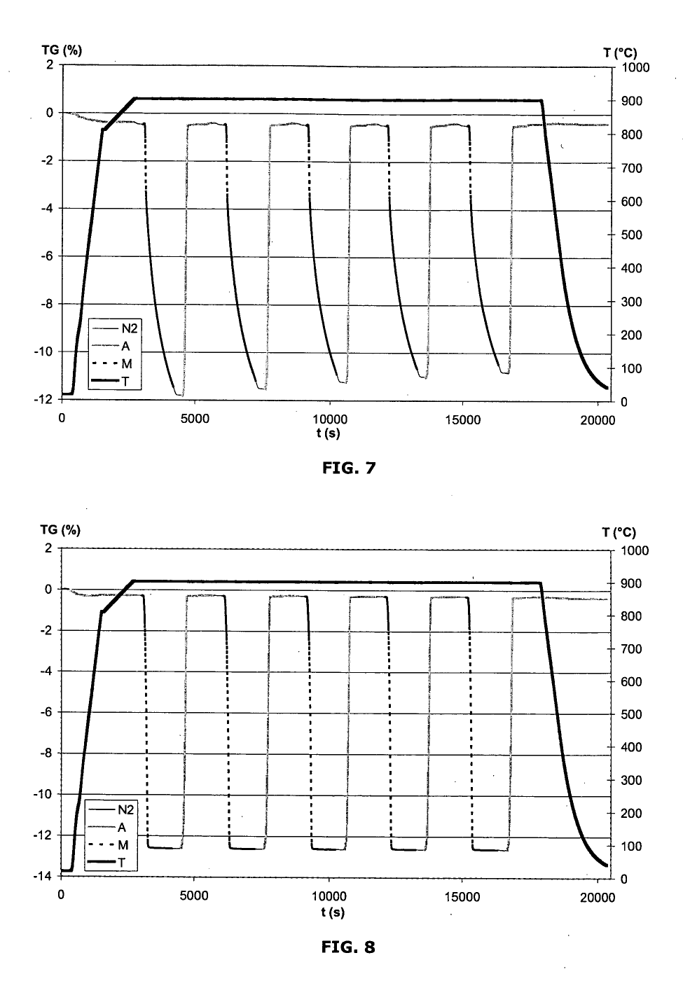

FIG. 7: Change in the mass of a sample of Example 7 as a function of the reducing or oxidizing atmosphere, at 900° C.

FIG. 8: Change in the mass of a sample of Example 8 as a function of the reducing or oxidizing atmosphere, at 900° C.

Table 2 reports the average reduction and oxidation rates measured for each sample corresponding to Examples 1 to 8.

TABLE 2

| | Reduction rate/mmol | Oxidation rate/mmol |
|---|---|---|
| Example | O₂/min · g | O₂/min · g |
| 1 | 1.27 | 1.66 |
| 2 | 0.96 | 1.54 |
| 3 | 0.86 | 1.65 |
| 4 | 1.40 | 2.94 |
| 5 | 1.28 | 1.90 |
| 6 | 1.28 | 1.66 |
| 7 | 0.77 | 2.46 |
| 8 | 0.72 | 2.01 |

The results obtained for the mass of the prior and the masses according to the invention are collated in FIGS. 1 to 8. These figures show the change in the relative weight loss and weight regain of the sample as a function of time for 5 successive reduction/oxidation cycles. In accordance with the protocol described above, the nature of the gases used varies during the progress of each cycle.

The reduction and oxidation rates are calculated from the slopes related to the mass loss and gain (respectively) observed, between the second and the third minute after passage in a reducing gas, and averaged over the five redox cycles.

FIGS. 1 to 7 show that all the materials having a spinel structure according to the invention are reduced by methane at 900° C. and re-oxidized by air at 900° C.

The spinel according to Example 1 (CuFeGaO₄) has an oxygen transfer capacity close to that of the redox mass according to the prior art. The reduction rate measured with the spinel of Example 1 is higher, and the oxidation rate lower.

The spinels of Examples 2 and 3 have oxygen transfer capacities which are substantially lower than that of the redox mass according to the prior art, but their reduction rates are higher.

The spinel of Example 4 has both a higher transfer capacity than that of the redox mass according to the prior art, and higher reduction and oxidation rates.

The spinel according to Example 5 (CuAlMnO₄) has an oxygen transfer capacity that is slightly lower than that of the redox mass according to the prior art, a higher reduction rate and a similar oxidation rate.

The spinel according to Example 6 (Cu_{0.5}Ni_{0.5}AlFeO₄) has a higher reduction and oxidation rates than those of the redox mass according to the prior art.

The spinel of Example 7 (Co_{0.5}Ni_{0.5}AlFeO₄) has a transfer capacity similar to those of the spinels of Examples 5 and 6. Its reduction rate is similar to that of the redox mass according to the prior art, but its re-oxidation rate is substantially higher.

These examples show the advantage of using redox masses according to the invention in a chemical looping combustion process.

1. Redox mass, said mass comprising at least one compound which corresponds to the formula AₓA′_{x′}B_{y}B′_{y′}O₄ and which crystallizes according to the spinel structure, where:
x and x′ are real numbers ranging between 0 and 1, with x+x′=1;
y and y′ are real numbers ranging between 0 and 2, with y+y′=2;
A and A′ are selected from Mg, Ca, Mn, Fe, Co, Ni, Cu, Zn and Cd;
B and B′ are selected from the group made up of Fe, Mn, Cr, V, Ce, La, Pr, Nd, Al, Ga and In;
when (A=Cu and 0.9≦x≦1) and (B=Al and y=1) and (B′=Fe and y′=1), A′ is other than Fe;
when (A=Cu and 0.9≦x≦1) and (A′=Fe and 0≦x′0.1) and (B=Fe and y=1), B′ is other than Al;
when (A=Cu and x=1) and (B=Al), then 0.1≦y≦1.9 and B′ is selected from Fe, Mn, Cr, V, Ce, La, Pr, Nd, Ga and In.

2. Redox mass according to claim 1, for which y is greater than or equal to 0.5; B is equal Al and B′ is selected from the group made up of Fe, Mn, Cr, V, Ce, La, Pr, Nd, Ga and In.

3. Redox mass according to claim 1, for which the synthesis of the compound AₓA′_{x′}B_{y}B′_{y′}O₄ is carried out in a coprecipitation step.

4. Redox mass according to claim 3, for which said coprecipitation step is carried out by coprecipitation of a mixture of metal precursors, chosen from the group of nitrates, acetates and oxalates, with a base.

5. Redox mass according to claim 1, in which no binder is combined.

6. Redox mass according to claim 1, said mass also comprising at least one binder chosen from ceria-zirconia, alumina, spinel type aluminates, silica, titanium dioxide, kaolin, yttria-stabilized zirconia, and perovskites.

7. Redox mass according to claim 6, in which the binder is introduced at a content of between 10% and 95% by weight.

8. Redox mass according to claim 1, also comprising at least one redox couple chosen from the group made up of CuO/Cu, Cu₂O/Cu, NiO/Ni, Fe₂O₃/Fe₃O₄, FeO/Fe, Fe₃O₄/FeO, MnO₂/Mn₂O₃, Mn₂O₃/Mn₃O₄, Mn₃O₄/MnO, MnO/Mn, Co₃O₄/CoO and CoO/Co.

9. Redox mass according to claim 1, said mass being in the form of powder, of beads, of extrudates, or of a washcoat deposited on a substrate of monolith type.

10. Chemical looping redox (CLC) process using a redox mass according to claim 1.

11. Chemical looping redox process according to claim 10, using an oxidation reactor and a reduction reactor, both operating in a circulating fluidized bed.

12. Chemical looping redox process according to claim 10, using a rotary reactor.

13. Chemical looping redox process according to claim 12, using a simulated rotary reactor.
